(19) United States
(12) Patent Application Publication
(10) Pub. No.: US 2025/0103265 A1
(43) Pub. Date: Mar. 27, 2025

(54) DYNAMIC TIME RECORDING DISPLAY SYSTEM FOR MULTIPLE USERS

(71) Applicant: William A Horan, West Hempstead, NY (US)

(72) Inventor: William A Horan, West Hempstead, NY (US)

(73) Assignee: GROUPCLOCK INC., Franklin Square, NY (US)

(21) Appl. No.: 18/895,921

(22) Filed: Sep. 25, 2024

Related U.S. Application Data
(60) Provisional application No. 63/585,580, filed on Sep. 26, 2023.

(51) Int. Cl. G06F 3/14; G06F 3/01; G06Q 10/1091; G06V 40/50

(52) U.S. Cl. CPC G06F 3/14; G06F 3/017; G06Q 10/1091; G06V 40/50

(57) ABSTRACT

A system and method for organizing and displaying time recording information on one or more electronic visual displays using biometric data to identify users and recognize time recording actions. Notification data is assigned to specific locations on the display, such as columns or rows, and may include appearance attributes like color or font. Algorithms manage the assignment, enabling balanced or randomized placement across the display. The system updates in real-time, with new notification data appearing at the top of a column or start of a row, shifting previous notifications. It supports multiple displays and adjusts as users are added or removed. Notification data may be removed after a predefined time, and users are informed electronically about their notification data's placement and appearance.

### CROSS-REFERENCE TO RELATED APPLICATIONS

This application claims the benefit of U.S. Provisional Application No. 63/585,580, filed on 26 Sep. 2023, which is incorporated herein by reference in its entirety.

### TECHNICAL FIELD

This invention relates generally to the time recording and time tracking field, and more specifically, to a new and useful system and method for organizing and presenting data on electronic visual displays.

### BACKGROUND

Businesses typically track the amount of time their employees spend at work using time clocks. These time clocks range from traditional mechanical devices, which require employees to punch paper cards, to more modern electronic systems, where employees swipe magnetic identification cards to record their time. A common challenge faced by businesses is that most time clocks are designed to register time for only one employee at a time, leading to bottlenecks when multiple employees attempt to record their time, especially at shift changes. This limitation can cause inefficiencies in processing large volumes of employees quickly and accurately.

Thus, there is a need in the automated employee time recording technical field to create improved systems and methods for an intelligent acceleration of time recording processes for a plurality of distinct time recording entities.

The present invention enables multiple users to perform time recording actions concurrently and provides a method for notifying them that the system has recognized their actions. Given the potentially limited size of a time recording space, notifying a user when their time recording action has been successfully recorded is important for ensuring that they vacate the space and make room for others to perform their own actions. The quicker users vacate the time recording space after their action is recognized, the more efficient the system becomes, as it can process more users in a given time. The embodiments described herein offer technical solutions, including the use of electronic visual displays to concurrently provide multiple users with a confirmation—referred to as a notification—of a successful time recording event. The system organizes the notification data on the display in a manner that facilitates quick human recognition, addressing the need for increased efficiency and overcoming limitations in the prior art.

### BRIEF SUMMARY OF THE INVENTION(S)

In some embodiments, multiple employees (also known as users, or time recording entities) may perform a time recording action concurrently within a monitored space, such as one observed by a scene capturing device like a video camera.

A time recording action can be any action, or pose, that the system is configured and/or trained to recognize. In some embodiments, a time recording action may be raising a hand over the head or above the shoulder line. This computerized system can recognize this action, or pose, and the system can perform a biometric recognition analysis, for example facial recognition, to identify the user and record the transaction. It should be noted that the biometric recognition analysis may be performed before or after a time recording action is performed.

In some embodiments, a time recording action may be raising an elbow above the shoulder line. A computerized system can recognize this action, or pose, and then a computerized system can perform a biometric recognition analysis, for example facial recognition, to identify the user and record the transaction.

The transaction record includes a unique user identifier (e.g., number) and the time that the action was performed. It may also include other information, including but not limited to a location identifier, a department identifier, a job identifier, and/or transaction type identifier, also known as a time recording activity or time recording event. A time recording activity may include, but not be limited to, an identifier for “clock in” (also known as “start of shift”), “clock out” (also known as “end of shift”), “out for lunch”, “in from lunch”, “out for break”, and/or “in from break”. In the context of the present invention, a time recording activity may include any action detected by the system that relates to time management. This can encompass specific “classified time recording activities” such as ‘clock-in’ or ‘clock-out,’ as well as more generalized “unclassified time recording activities” that are logged without immediate classification as a specific time recording activity. Such unclassified time recording activities may be later interpreted or classified based on the timestamp of the activity, contextual analysis, or other data processing rules. The later interpretation of these activities may be performed by this system or by an external or third-party system.

The present invention utilizes an electronic visual display(s) to inform a user that they have successfully performed a time recording action. In a preferred embodiment, a scene capturing device, such as a video camera(s), may be mounted on a wall or ceiling and would be monitoring a given area. The visual display(s) (also known as a monitor, screen, TV, etc.) may be mounted in close proximity to the scene capturing device. When the system detects that the user successfully performed a time recording action then information may be displayed on the visual display to notify the user that the transaction was recorded by the system. This time recording information, also referred to as “notification data, “confirmation data”, or just “data”, may contain information such as the user's name, their unique identifier, the time the transaction was recorded, and/or information about the time recording activity that was logged by the system. When the user sees this data on the display, they can then vacate the time recording space. In order to facilitate a large number of users to quickly perform the time recording action, the system may be designed to organize the information using multiple columns on the visual display and/or multiple colors where notification data for each unique user may be preassigned to a specific column and a specific color by one or more computers, running one or more algorithms. In another embodiment, multiple visual displays can be used. The user may have the knowledge beforehand about what column they are assigned to and what color the information may be displayed in. If multiple visual displays are being used, the users may know beforehand which visual display that their information may appear on. The color of the notification data, may appear in a specific preassigned color. Alternatively, there may be a shape, such as a rectangle for example, and that shape may be a specific preassigned solid color and the text may appear inside that shape where the text may, for example, be a lighter color if the background fill color of the shape is a darker shade color, or alternatively, the text may be a darker color if the background fill color of the shape is a lighter shade color. The purpose of this being to ensure enough contrast between the text and background so that it may be easily legible by the user. Additional appearance attributes may be assigned to the notification data, including but not limited to, font, font style, and font size.

In some embodiments the invention may consist of a user enrollment module. This user enrollment module may perform the following functions. 1) registers the user's name and/or unique identifier 2) assign the user to a specific area on a visual display 2) biometric data collection which may include data used for constructing a facial signature of the target user, a vocal/voice signature of the target user, a gait (e.g., stride) signature of the target user, and/or the like.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application; and

FIG. 3 illustrates an example schematic for evaluating time recording activities performed by a plurality of bodies identified in a time recording data stream in accordance with one or more embodiments of the present application.

FIG. 4 illustrates an example schematic of a notification module 170 using four electronic visual displays (screens) with three columns per screen in accordance with one or more embodiments of the present application.

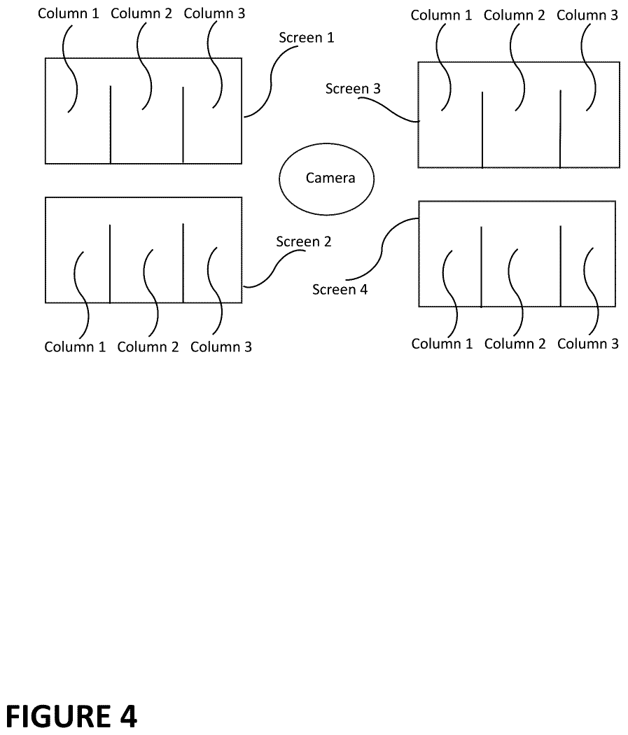

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### 1. System for Automated Electronic Time Recording

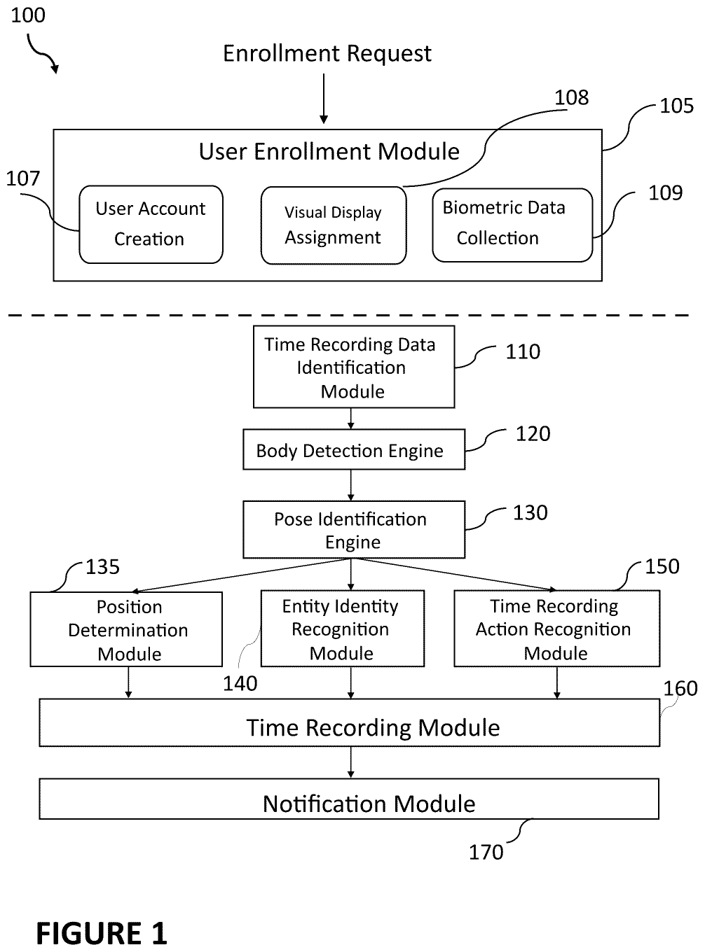

As shown in FIG. 1, a system 100 for automated electronic time recording may include a user enrollment module 105, a time recording data identification module 110, a body detection engine 120, an entity identification recognition module 140, a time recording action recognition module 150, a time recording module 160, and a notification module 170. In some embodiments, the user enrollment module 105, as shown in FIG. 1, may include a user account creation module 107, a visual display assignment module 108, and a biometric data collection module 109. Additionally, as shown in FIG. 1, the system 100 may optionally include a position determination module 135.

### 1.05 User Enrollment Module

The user enrollment module 105 may function to receive a request to enroll a target user to the system 100 (“enrollment request”). The enrollment request received by the user enrollment module 105 may have been initiated/triggered by the target user or on behalf of the target user (e.g., via an administrator of the system 100). In some embodiments, in response to the user enrollment module 105 receiving the request to enroll the target user to the system 100, the user enrollment module 105 may execute the user account creation module 107 and/or the visual display assignment module 108 and/or the biometric data collection module 109, which will now be described.

It shall be noted that the user enrollment module 105 may function to receive a plurality of requests for enrolling a plurality of target users to the system 100, and in such cases, the user enrollment module 105 may function to process the plurality of requests sequentially or concurrently.

### 1.07 User Account Creation Module

The user account creation module 107 may function to create a user account for the target user. That is, the user account creation module 107 may function to create a user account for the target user associated with the enrollment request received by the user enrollment module 105. Creating the user account for the target user may include collecting information associated with the target user, such as a name of the target user, an address of the target user, a profile photo of the target user, and/or the like.

Creating the user account for the target user may also include creating or assigning a unique identifier to the target user. This unique identifier assigned to or created for the target user may be used, by the system 100, to delineate time recording activities performed by the target user from time recording activities performed by other users of the system 100. It shall be noted that after the user account creation module 107 creates a user account for the target user, the target user may then be able to interact with and/or access user interfaces provided by the system 100. The unique identifier for each user may be assigned either before, during, or after the biometric data collection. In cases where the biometric data is collected first, the system is configured to associate the biometric data with a unique identifier once it has been created, ensuring proper identification and linking of user information for subsequent time recording activities.

### 1.08 Visual Display Assignment Module

The visual display assignment module 108 may be configured to assign a user's notification data to a specific electronic visual display within the notification module 170, to a specific column or row on that display, and, optionally, to a specific appearance attribute such as color, selected from a plurality of colors, in which the user's notification data may appear when the system recognizes the user has performed a time recording action, as determined by the time recording module 160. In a preferred embodiment, each visual display would have at least two columns or two rows. If no specific color is assigned, then the notification data will appear in a default color where the default color is predetermined by the system or configured by an administrator. The visual display assignment module may also maintain a dynamic record of previous assignments, updating as new users are enrolled or removed from the system. Multiple users' notification data may share the same column or row on the same display and the same color. To automate the placement and appearance of notification data, the visual display assignment module 108 may implement an assignment algorithm, running on one or more computers, or another suitable process. This assignment algorithm may randomly assign users' notification data to a display, column or row, and optionally, color, without regard to specific rules or patterns, thereby creating a randomized distribution of notification data across available displays, columns, rows, and colors. Alternatively, the assignment algorithm may be used to achieve a balanced distribution of users' notification data. A balanced distribution is defined as the system attempting to assign an equal number of users' notification data to each display, an equal number of users' notification data to each column or each row, and, where multiple colors are used, an equal number of users' notification data to each color within each column or row on the available displays. The goal is to avoid visual clustering, ensuring clarity and visibility of users' activities on the display. The notification data assigned to users may include their first name, last name, unique identifier, and the time and date of the time recording action. Additionally, the notification data may include information about the time recording activities detected by the time recording action recognition module 150.

Additionally, or alternatively, the system may assign users' notification data to one or more specific appearance attributes, including but not limited to, font, font style, and/or font size, such that each unique user is assigned only one font selected from a plurality of fonts, one font style selected from a plurality of font styles, and/or one font size selected from a plurality of font sizes, while allowing multiple users to share the same font, font style, and/or font size. The assignment of fonts, font styles, and/or font sizes is automatically performed by one or more algorithms running on one or more computers, either randomly or in such a way as to maintain a balanced distribution across the columns or rows on the electronic visual display(s). A balanced distribution is defined as the system attempting to assign an equal number of users' notification data to each column or row, ensuring that no single column or row contains a disproportionate amount of data that shares the same font, font style, or font color, or any other appearance attributes that may be assigned. If notification data is not assigned to a specific font, font style, and/or font size, then the notification data will appear in a default font, font style, and/or font size predetermined by the system or configured by an administrator.

In some embodiments, the color of the notification data may appear in a specific assigned color associated with each user. In one embodiment, the text of the notification data itself is displayed in the assigned color without any additional shapes or background. For example, if a user's assigned color is blue, the text displaying their notification data appears in blue font directly on the electronic visual display. This method allows users to quickly identify their notification data based solely on the color of the text. Alternatively, there may be a shape, such as a rectangle, and that shape is filled with the user's assigned color. The text of the notification data then appears inside that shape. To ensure legibility, the text color contrasts with the assigned background fill color. For example, if the background fill color of the shape is a dark shade like navy blue, the text may appear in white or light gray. Conversely, if the background fill color is a light shade like pale yellow, the text may appear in black or dark gray. This approach ensures enough contrast between the text and background so that it is easily legible by the user. In both embodiments, the purpose of assigning specific colors—whether to the text itself or to the background shape—is to facilitate accelerated human recognition of notification data. Users can quickly locate their information on the display based on their preassigned color, enhancing the efficiency of the time recording process. These examples are illustrative and not intended to limit the scope of the invention, as other shapes, colors, and methods of displaying the notification data may be employed to achieve sufficient contrast and visual clarity.

To achieve a balanced distribution of notification data across one or more electronic visual displays, the system may utilize various algorithms and methods, depending on specific implementation requirements such as the number of users, displays, and the desired balance. Examples of such algorithms include hashing algorithms, such as consistent hashing, which assign unique user data to specific displays and positions, efficiently adapting to changes in user or display numbers. Load-balancing algorithms like round-robin or weighted round-robin sequentially or preferentially assign data to displays based on predetermined criteria to ensure even distribution. Clustering algorithms, including k-means and hierarchical clustering, group users by characteristics like department or shift and distribute data accordingly, maintaining balance within and across clusters. Graph-based algorithms, such as graph partitioning and minimum cut methods, model data placement as a graph to find optimal distributions under multiple constraints. Optimization algorithms—for instance, genetic algorithms and simulated annealing—find optimal or near-optimal distribution strategies in complex search spaces. Machine learning techniques like reinforcement learning and predictive analytics adaptively improve distribution strategies based on historical data and patterns. Heuristic algorithms, such as greedy algorithms and tabu search, quickly assign notification data based on heuristic rules that approximate balanced distribution. Dynamic allocation strategies adjust allocations in real-time based on the current system state using feedback control algorithms. Custom algorithms tailored to the system's unique requirements may also be employed, possibly combining elements from various techniques to address specific constraints. The system may use any of these algorithms, alone or in combination, to achieve a balanced distribution and dynamically adjust its approach based on real-time performance metrics. This invention encompasses any algorithm or method that achieves balanced distribution, not limited to those explicitly described here.

The visual display assignment module 108 may also function to communicate the placement and appearance of a user's notification data, ensuring users know where to focus their attention on the visual display. This information can be delivered through various electronic means, including but not limited to email, mobile applications, text messages, native applications, or web applications. Visual displays, as well as columns or rows, may be labeled or numbered, either displayed on-screen, affixed to the display or its borders with stickers or labels, or placed near the screens. This labeling information is then communicated to the users. Additionally, or alternatively, a diagram of the visual display layout may be provided, showing users where their notification data will appear. Any assigned appearance attributes, including but not limited to colors, fonts, font styles, and font sizes for the notification data may also be conveyed to the users. These examples are not meant to limit the invention; the system may employ any suitable method for identifying a display and its layout.

The following are some examples of a system with one electronic visual display and also an example of a system that utilizes a plurality of electronic visual displays. An example of a one-display system may be where the display has three columns and there are five different colors in which the users' notification data can appear. If there is a total of 90 users, the system may automatically assign 30 users' notification data to each column, and within each column, there are six users whose notification data is assigned the same color. Another example may be a system with four screens that each have four columns. If there are a total of 320 users, the system may automatically assign 20 users' notification data to each column, as there would be 16 total columns divided among the four screens. If five different colors are used in this example, then there may be four users in each column whose notification data is assigned the same color. In this most recent example, if there are only 318 users, there may not be a perfectly balanced distribution. However, when new users are added to the system, the system may automatically assign their notification data to a screen, column, and color to bring the distribution closer to balanced. Furthermore, when a user is removed from the system, as in when an employee leaves an organization, the system may assign the new user to the same screen, column, and color as the user who was removed to maintain as balanced a distribution as possible. Alternatively, users' notification data may be assigned randomly by the system without regard to balancing across displays, columns, rows, colors, font, font style, or font size. In either case, additional displays, columns, rows, colors, fonts, font styles, and/or font sizes may be added after the system has been in use, whether the assignment of notification data follows a balanced distribution approach or a randomized assignment approach. These examples are presented to provide clarity to the invention and are not meant to limit it in any way. The system can accommodate any number of displays, columns, rows, and appearance attributes, including but not limited to, colors, fonts, font styles, and/or font sizes. The number of displays, columns, rows, colors, fonts, font styles, and/or font sizes may be predefined by the system or by an administrator before the assignment begins. Displays, columns, rows, colors, fonts, font styles, and/or font sizes may also be added after the system has been in use to accommodate additional users or operational needs, ensuring the system remains scalable and adaptable in both balanced and random configurations.

Additionally, or alternatively, the assignment to a visual display, column, color, font, font style, font size, and any other appearance attribute, may be manually entered by a system administrator, either at the time of initial enrollment or at any time afterwards. Also, if the system is automatically making the assignment, a system administrator may be able to edit that assignment at any time. An example where this may be useful may be when a user has a certain form a color blindness and cannot perceive certain colors.

In a preferred embodiment, the system may be programmed to avoid assigning users with the same first and last name to the same column, or row if organized by row, in order to avoid confusion by the users. Alternatively, the system may be programmed to avoid assigning users with the same first name or the same last name to the same column, or row if organized by row.

Additionally, or alternatively, the system may use information about the users' assigned work schedules in order to assign them to a visual display, column, and/or color such that at the most likely times they may be performing a time recording action, the associated notification data may have a balanced distribution amongst visual displays, columns, and/or colors with other users that share the same work schedule and may therefore be using the system at or around the same time. Information about the work schedule may be manually entered by a system administrator or ascertained electronically from a software application database.

In some embodiments, the system may be programmed to reassign notification data for multiple users in bulk using the aforementioned algorithmic process. This functionality can be particularly useful in scenarios where a display in a multi-display configuration malfunctions or becomes unavailable. In such cases, the system may automatically reassign the notification data of users previously assigned to the malfunctioning display to one or more of the remaining functional displays. The reassignment process ensures that the placement of the notification data maintains the balanced or randomized distribution criteria established by the system. Once the reassignment is completed, affected users may be notified of their new display placement through the electronic means previously described (such as email, text message, mobile applications, native applications, or web applications). This notification will include details about the new placement, such as the specific display, column or row, and, optionally, any assigned appearance attributes (such as color, font, font style, and/or font size), ensuring users know where to look for their updated notification data.

### 1.09 Biometric Data Collection Module

The biometric data collection module 109 may function to collect biometric data corresponding to the target user. The biometric data collected by the biometric data collection module 109 may include data used for constructing a facial signature of the target user, a vocal/voice signature of the target user, a gait (e.g., stride) signature of the target user, and/or the like.

In a preferred embodiment, the biometric data collection module 109 may be installed to an electronic device associated with the target user (e.g., a mobile application). In such embodiments, the biometric data collection module 109 may function to provide the target user with instructions for capturing the required biometric data and/or interface with one or more hardware components of the electronic device to capture the required biometric data of the target user.

Additionally, or alternatively, the biometric collection module 109 may be installed to one or more administrative systems and/or computing devices. In such embodiments, the biometric data collection module 109 (or similar enrollment module) may enable an administrator to collection biometric data of one or more users (e.g., employees and/or the like) of the system 100. In one or more embodiments, the biometric data collection module 109, as implemented for an administrator, may be in operable communication with one or more of a biometric data capturing device (e.g., cameras, bio scanners, and/or the like), a storage system, a time recording application (for creating a unique identifier), and/or the like.

### 1.10 Time Recording Data Identification Module

The time recording data identification module 110 may function to identify a time recording data stream. The time recording data stream identified by the time recording data identification module 110 may have been captured via one or more cameras of the system 100 and/or captured via one or more cameras in communication with the system 100. The one or more cameras of the system 100 or the one or more cameras in communication with the system 100 may be referred to herein as “scene capturing devices.”

Preferably, the time recording data stream includes a plurality of frames or images that correspond to past, current, and/or recent activity occurring in a designated time recording space, such as a parking lot, hallway, room, or a factory floor of a facility. Accordingly, in such embodiments, one or more frames or images of the time recording data stream may include one or more representations of one or more bodies moving through the time recording scene with no intention of interacting with system 100, one or more representations of one or more stationary bodies performing time recording activities in the designated time recording space, and/or one or more representations of one or more bodies moving (e.g., walking, running, etc.) through the designated time recording space while performing a time recording activity.

It shall be noted that the time recording data stream identified by the time recording data identification module 110 may have been captured via other types of scene capturing devices, including, but not limited to, LIDAR sensors, infrared sensors, microphones, and/or thermographic sensors.

### 1.20 Body Detection Engine

The body detection engine 120 may function to receive the time recording data stream identified by the time recording data identification module 110 and detect if one or more bodies exist in the time recording data stream. To detect if one or more bodies exist in the received time recording data stream, the body detection engine 120 may preferably implement a body detection algorithm that includes human body edge detection capabilities.

In addition, or as an alternative, to the above-described body detection algorithm, the body detection engine 120 may implement any other suitable human body detection process or algorithm for identifying if one or more bodies exist within the received time recording data stream. It shall be noted that, in some cases, when the body detection engine 120 detects a plurality of bodies in the time recording data stream, the system 100 may function to instantiate and execute one or more of the modules 130-170 for each of the plurality of bodies such that time recording activities potentially performed by each of the plurality of bodies can be detected in parallel (as opposed to detected sequentially).

### 1.30 Pose Identification Engine

The pose identification engine 130 may function to identify a pose for one or more of the bodies identified in the time recording data stream. In some embodiments, to detect a pose for one or more of the bodies identified in the time recording data stream, the pose identification engine 130 may preferably implement a pose detection model. The pose detection model may function to receive an image of a respective body as input and, in turn, detect one or more body parts captured in the provided image of the respective body and/or determine a position or location of the one or more detected body parts (e.g., X, Y, and/or Z coordinates).

Based on the computed positions of one or more of the detected body parts, the pose identification engine may function to evaluate/determine if the respective body satisfies time recording pose criteria. It shall be noted that in addition, or as an alternative, to the pose detection model, the pose identification engine 130 may implement any other suitable pose detection process or algorithm for identifying a pose for the one or more of the bodies identified in the time recording data stream.

### 1.35 Position Determination Module

The pose determination module 135 may function to receive, from the pose identification engine 130, the positions/locations of one or more body parts of the target body. In turn, the position determination module 135 may compare the positions/locations of the one or more body parts of the target body to known time recording zones located in the time recording space to determine the time recording zone in which the target body may be located. It shall be noted that in addition, or as an alternative, to the above description the position determination module 135 may function to determine a position/location of a target body in the time recording space via any other body position detection model.

### 1.40 Entity Identity Recognition Module

The entity identity recognition module 140 may function to detect an identity for one or more of the bodies detected in the time recording data stream. In some embodiments, to detect an identity associated with one or more of the bodies detected in the time recording data stream, the entity identity recognition module 140 may preferably implement an identity detection model. The identity detection model may function to receive a portion of a respective body as input (e.g., the head of the body) and derive an identity associated with the respective body as output, such as a name corresponding to the respective body, an identification number associated with the respective body (e.g., as described with respect to the user enrollment module 105), contact information associated with the body, and/or the like.

Additionally, or alternatively, to the embodiment described above, S230 may function to compare the portion of the respective body (e.g., the head of the body) to a database that includes stored facial images of potential users and/or facial image features (e.g., eyes, nose, ears, lips, chin, etc.) of the potential users to derive an identity of associated with the respective body.

### 1.50 Time Recording Action Recognition Module

The time recording action recognition module 150 may function to detect or recognize a time recording action (or gesture) performed by one or more of the bodies detected in the time recording data stream. In some embodiments, to detect the time recording action performed by one or more of the bodies detected in the time recording data stream, the time recording action recognition module 150 may function to implement a time recording action recognition algorithm or model. The input provided to the time recording action recognition algorithm may correspond to a portion of a respective body (e.g., an image of a hand) and provide a name of the time recording activity performed by the respective body as output and/or provide a corresponding time recording code as output.

Time recording activities that may be detected by the time recording action recognition module 150 may include hand gestures for registering for work (“clock-in”), hand gestures for finishing work (“clock-out”), hand gestures for changing current labor task (“task change/transfer”), hand gestures for registering for a break (“break start”), hand gestures for ending the break (“break end”), hand gestures for registering for a meal (“lunch start”), hand gestures for ending the meal (“lunch end”), and/or the like.

Additionally, or alternatively, each of the body detection engine 120 (e.g., pixellib or the like), pose identification engine 130 (e.g., mediapipe or the like), pose determination module 135, entity identity recognition module 140, time recording action recognition module 150 (e.g., mobilenet or the like) may implement one or more ensembles of trained machine learning models. In some embodiments, a single machine learning model or ensemble of models may be configured to perform multiple functions across these modules. For example, a unified model may simultaneously perform action recognition and user identification by processing shared features from the data stream. This integrated approach can improve processing efficiency and accuracy by leveraging common data representations and reducing computational redundancy. The one or more ensembles of machine learning models may employ any suitable machine learning including one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), adversarial learning, and any other suitable learning style. Each module of the plurality can implement any one or more of: a machine learning classifier, computer vision model, convolutional neural network (e.g., ResNet), visual transformer model (e.g., ViT), object detection model (e.g., R-CNN, YOLO, etc.), regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a semantic image segmentation model, an image instance segmentation model, a panoptic segmentation model, a keypoint detection model, a person segmentation model, an image captioning model, a 3D reconstruction model, a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, density-based spatial clustering of applications with noise (DBSCAN), expectation maximization, etc.), a bidirectional encoder representation from transformers (BERT) for masked language model tasks and next sentence prediction tasks and the like, variations of BERT (i.e., ULMFIT, XLM UDify, MT-DNN, SpanBERT, ROBERTa, XLNet, ERNIE, KnowBERT, VideoBERT, ERNIE BERT-wwm, MobileBERT, TinyBERT, GPT, GPT-2, GPT-3, GPT-4 (and all subsequent iterations), ELMo, content2Vec, and the like), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. For instance, a convolutional neural network may be designed to output both action recognition and user identification results from the same input data, utilizing shared layers and optimizing jointly for both tasks. However, any suitable machine learning approach can otherwise be incorporated in the system 100. Further, any suitable model (e.g., machine learning, non-machine learning, etc.) may be implemented in the various systems and/or methods described herein. It should also be noted that any of the methods or models (whether machine learning-based or non-machine learning) described in this section may be used not only for the tasks mentioned, such as body detection, pose identification, pose determination, entity identity recognition, and/or time recording action recognition, but also for assigning notification data to a display placement and/or appearance attribute(s). For example, one or more machine learning methods may perform all of these tasks, including the assignment of notification data. Furthermore, any of the methods or models may run on one or more computers, where any combination of methods or models—including a single method or model—can run on a single computer, on separate computers, or in any combination thereof.

### 1.60 Time Recording Module

The time recording module 160 may function to record time recording activities performed by one or more of the bodies detected in the time recording data stream to a time recording database of the system 100 or to a time recording database in communication with the system 100. To record or register a time recording activity performed by a body in the time recording data stream, the time recording module 160 may function to receive, as input, a pose identified by the pose identification engine 130, the time recording zone in which the body may be located from the position determination module 135, receive the user/identity associated with the body from the entity identity recognition module 140, and/or receive the time recording action performed by the body from the time recording action recognition module 150.

In response to the time recording module 160 receiving the above-described data (inputs), the time recording module 160 may function to construct and record a time recording entry to the time recording database. The time recording entry may include information indicating that, at a particular time, the user associated with the detected body performed a particular time recording activity while located within a particular time recording zone. It shall be noted that a time recording zone may not be required to be specified in order to record time to the time recording database. Additionally, it shall also be noted that recording a time entry to the time recording database may cause a time recording state for the user associated with the time recording entry to be updated accordingly (e.g., change from being in a clocked-in state to being in a clocked-out state).

### 1.70 Notification Module

The notification module 170 may function to notify a target user when (or after) a time recording entry has been successfully registered for the target user. That is, in response to the time recording module 160 registering a time recording activity to a time recording database, or a time recording action being recognized by the system, the notification module 170 may function to display, via a display generation component of the system 100, a notification that indicates attributes or characteristics about the recently registered time recording activity. The system may communicate data to the display using any suitable wired or wireless communication method, including but not limited to HDMI, DisplayPort, USB-C, Ethernet, or wireless methods like Wi-Fi or Bluetooth. The notification data may be organized and displayed in a manner determined by the visual display assignment module 108. All notification data displayed on the electronic visual display(s) may be programmed to be removed after a predetermined amount of time elapses, which is either hard-coded or defined by an administrator, without a time recording action being recognized by the system. Alternatively, notification data may be programmed to be removed on a rolling basis, where each unique notification is removed after a predetermined amount of time elapses from its first appearance, this amount of time being either hard-coded or defined by an administrator. Notification data may be refreshed on the display in real-time or at a predetermined interval. The term “real-time” refers to updates to the electronic visual display that occur substantially immediately after the corresponding time recording action is recognized by the system, accounting for any minimal processing delays that may arise due to the system's operational constraints. Additionally, or alternatively, the notification module 170 may function to transmit, to an electronic device associated with the target user, a notification that indicates attributes or characteristics about the recently registered time recording activity. This notification may be communicated by electronic means, including but not limited to text message, email, or through a mobile, native, or web application.

In a preferred embodiment, when a time recording action is recognized by the system and the user is biometrically identified, the notification data for that user may be displayed at the top of a vertically oriented column. It may remain in that position until a new time recording action is successfully performed by another biometrically identified user whose notification data is assigned to the same column. At that time, the new notification data may appear at the top of said column, and the notification data from the previous user may shift down one row. As new notification data is displayed in the same column, all previous notification data within that same column may shift down one row accordingly. If the same user performs consecutive time recording actions without another biometrically identified user performing a time recording action in between, the notification data for that user may be displayed consecutively in the column, each entry retaining its originally assigned appearance attributes, such as color, font, font style, and font size, as it shifts downward. The notification data retains its originally assigned appearance attributes throughout this process, even if the notification data displayed has different attributes than the notification data in the position that it is moving into. This ensures that the notification data preserves its visual identity as it moves down the column, aiding in rapid user recognition. When the notification data reaches the bottom of the column and there is no longer space to display additional data, the oldest notification data at the bottom of the column may be removed from the display to make room for the new notification data at the top.

Additionally, or alternatively, when a time recording action is recognized by the system and the user is biometrically identified, the notification data for that user may be displayed at the beginning of a horizontally oriented row. It may remain in that position until a new time recording action is successfully performed by another biometrically identified user whose notification data is assigned to the same row. At that time, the new notification data may appear at the beginning of said row, and the notification data from the previous user may shift to the right, moving one position across the row. Alternatively, in some configurations, the notification data may shift to the left, depending on system preferences. As new notification data is displayed in the same row, all previous notification data within that same row may shift accordingly. If the same user performs consecutive time recording actions without another biometrically identified user performing a time recording action in between, the notification data for that user may be displayed consecutively in the row, each entry retaining its originally assigned appearance attributes, such as color, font, font style, and font size, as it shifts across the row. The notification data retains its originally assigned appearance attributes throughout this process, even if the notification data displayed has different attributes than the notification data in the position that it is moving into. This ensures that the notification data preserves its visual identity as it moves across the row, aiding in rapid user recognition. When the notification data reaches the end of the row and there is no longer space to display additional data, the oldest notification data at the far right (or left, depending on system configuration) of the row may be removed from the display to make room for the new notification data at the beginning of the row.

### 2. Method for Automated Electronic Time Recording

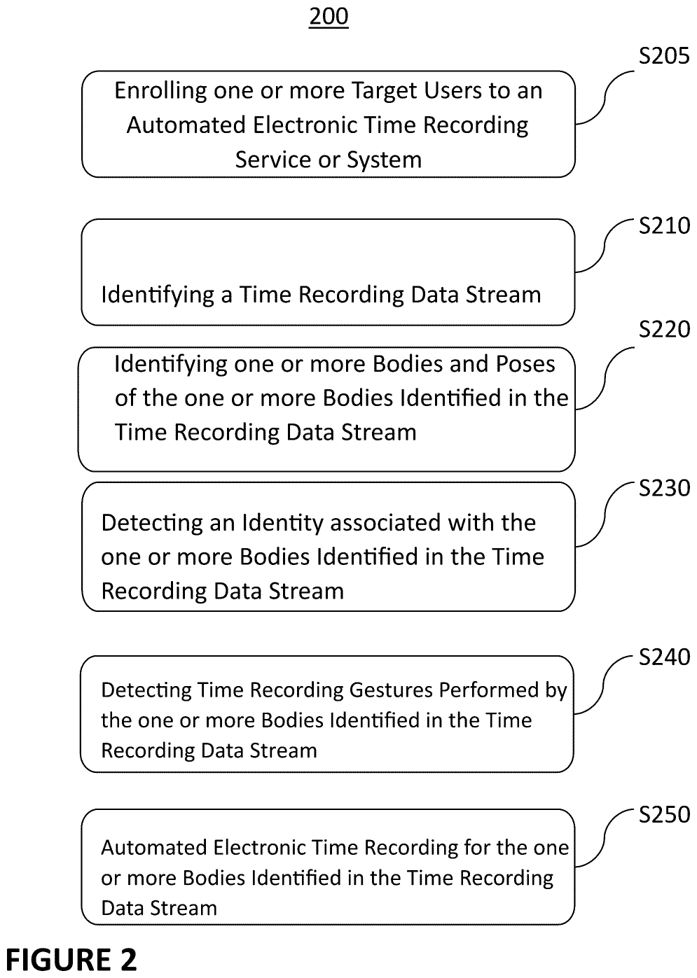

As shown in FIG. 2, the method 200 for automated electronic time recording includes enrolling one or more target users to an automated electronic time recording system or service (S205), identifying a time recording data stream (S210), identifying one or more bodies and poses of the one or more bodies in the time recording data stream (S220), detecting an identity associated with the one or more bodies identified in the time recording data stream (S230), detecting time recording gestures performed by the one or more bodies identified in the time recording data stream (S240), and automated electronic time recording for the one or more bodies identified in the time recording data stream (S250).

### 2.05 User Enrollment|Biometric Data Collection

S205, which includes enrolling a target user, may function to enroll the target user to an automated electronic time recording system or service (e.g., system 100). Enrolling the target user to the automated electronic time recording service may include creating a user account for the target user and/or may include associating the created user account with biometric data corresponding to the target user. The user account created for the target user may enable the automated time recording service to receive time recording signals from the target user without requiring the target user to physically touch an input element of the automated electronic time recording service, as will be described in more detail herein.

### Creating a User Account

In one or more embodiments, creating a user account for the target user includes creating or assigning a unique identifier (e.g., User ID) to the target user. The unique identifier assigned to or created for the target user may be used, by the automated electronic time recording service, to delineate time recording activities performed by the target user from time recording activities performed by other users of the automated time recording service, as will be described in more detail in S250. In a first implementation, the unique identifier of the target user may be automatically created or generated by the automated electronic time recording service (e.g., not influenced by user provided input). Alternatively, in a second implementation, S205 may assign a unique identifier to the target user based on a user provided unique identifier or an administrator provided unique identifier (e.g., use a provided email address as the unique identifier, an alphanumeric value, number, and/or the like).

### Biometric Data

In one or more embodiments, S205 may also function to collect biometric data corresponding to the target user. The biometric data collected by S205 may include data used for constructing a facial signature of the target user, a vocal/voice signature of the target user, a gait (e.g., stride) signature of the target user, and/or the like. In a preferred embodiment, S205 may function to collect such biometric data via an (e.g., mobile) application provided by the automated electronic time recording service. In such embodiments, the application provided by the automated electronic time recording service may function to provide the target user with instructions for capturing the required biometric data (e.g., instructions for capturing one or more facial characteristics of the target user, one or more walking characteristics of the target user, one or more voice characteristics of the target user, and/or the like). Additionally, the application provided by the automated electronic time recording service may be installed on an electronic device associated with the target user and/or function to interface with one or more hardware components (e.g., a camera, microphone, biometric data-capturing device, fingerprint reader, and/or the like) of the electronic device to capture the required biometric data of the target user.

After collecting the biometric data corresponding to the target user, S205 may function to digitally associate or link the collected biometric data of the target user to the unique identifier assigned to/created for the target user (e.g., store biometric data and user identifier data in a suitable data structure, such as a data table, or the like). As will be described in more detail herein, digitally linking the biometric data of the target user to the unique identifier of the target user may enable the automated electronic time recording service to recognize, detect, and/or identify users interacting the automated electronic time recording service.

It shall be noted that while the above description describes examples of enrolling a single target user to the automated electronic time recording service, S205 may function to enroll a plurality of target users to the automated electronic time recording service in analogous ways described above.

### 2.10 Scene Identification

S210, which includes identifying a time recording data stream, may function to receive or capture a time recording data stream or one or more images or recordings of a scene that may include representations of one or more users enrolled in the automated electronic time recording service performing time recording gestures or actions. In some embodiments, the time recording data stream may additionally, or alternatively, include representations of one or more users that are not enrolled in the automated electronic time recording service and/or include representations of one or more users enrolled in the automated electronic time recording service that are not performing a respective time recording activity/gesture. It shall be noted that, for ease of description in some parts of the disclosure, a representation of a user in the time recording data stream may simply be referred to as “a user included in the time recording data stream.”

Time recording gestures, as generally referred to herein, may be air gestures that users can physically perform to record time activities to the automated electronic time recording service, such as air gestures to register for work (“clock-in”), air gestures to finish work (“clock-out”), air gestures to change current labor task (“task change/transfer”), air gestures to register for a break (“break start”), air gestures to end the break (“break end”), air gestures to register for a meal (“lunch start”), air gestures to end the meal (“lunch end”), and/or the like. Additionally, or alternatively, time recording gestures may correspond to implicit or non-specific time recording activities, which may also be referred to as unclassified time recording activities (e.g., air gestures used to record a new time activity/action to the automated electronic time recording service without explicitly specifying the time activity/action type). Additional details relating to the time recording gestures will be described in further detail at S240.

In a preferred embodiment, the time recording data stream may be a video stream captured via one or more video cameras (e.g., one or more scene capturing devices). The one or more video cameras may be installed in a physical location/facility associated with one or more target users (employees) and/or may be wide field-of-view cameras capable of capturing or recording physical activity of the one or more target users (employees) within a designated time recording space or scene (e.g., one or more hallways, one or more rooms, one or more factory floors of a physical facility associated with an employer, and/or the like). Accordingly, in one or more embodiments, the time recording data stream captured via the one or more video cameras may include representations of a plurality of users (employees) moving through the time recording scene with no intention of interacting with the automated electronic time recording service, representations of a plurality of stationary users (employees) performing time recording gestures in the time recording scene, representations of a plurality of users (employees) moving through the time recording scene while performing time recording gestures, and/or the like.

In some embodiments, the time recording scene includes distinct time recording zones or areas. These distinct time recording zones may correspond to distinct tasks with which a performed time recording gesture may be associated. For instance, if a first user performs a first time-recording gesture while located within a first time recording zone, the first time recording gesture may be intended to correspond to a first job task. Conversely, if the first user performs the first time recording gesture while located within a second time recording zone, the first time recording gesture may be intended to correspond to a second job task (different than the first job task). Accordingly, in such embodiments, the time recording data stream may include representations of the time reporting zones/areas located within the time reporting scene such that the automated electronic time recording service may gauge time recording intent of the one or more users in the time reporting space/scene.

Alternatively, the time recording data stream may not be captured via one or more video cameras, but rather captured via any other scene capturing device capable of capturing activity of one or more users within the time reporting scene (e.g., LIDAR sensors or cameras, infrared sensors or cameras, thermographic sensors or cameras, microphones, and/or the like).

### 2.20 Body & Pose Detection|Time Recording Intent

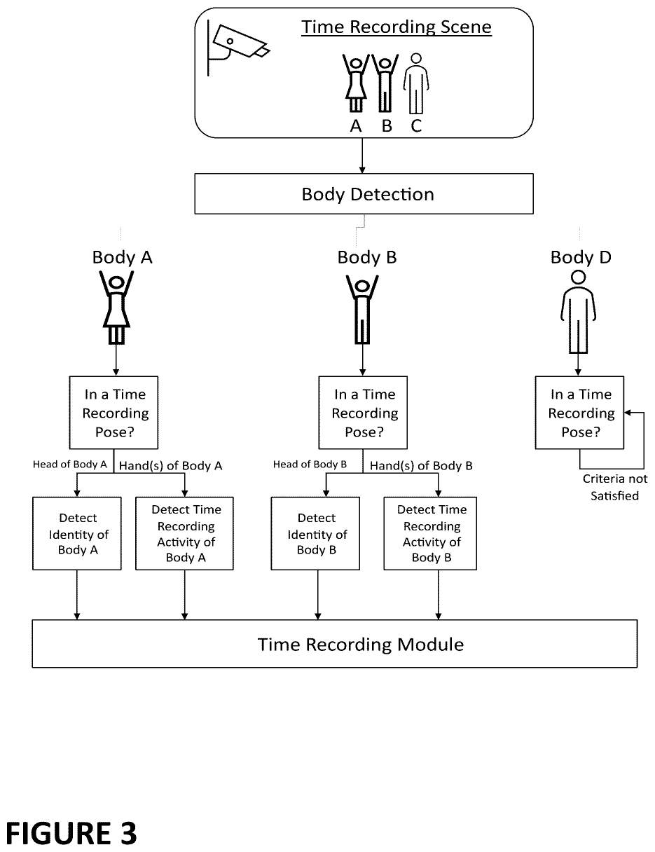

S220, which includes detecting bodies and poses, may function to detect if one or more bodies exist in the time recording data stream identified by S210 and/or detect if the one or more bodies captured in the time recording data stream satisfy time recording pose criteria. Additionally, or alternatively, S220 may function to trigger concurrent or parallel time recording processes for the one or more bodies detected in the time recording data stream, as generally illustrated in FIG. 3.

### Body Detection

In one or more embodiments, to determine if one or more bodies exist in the time recording data stream, S220 may function to implement a body detection algorithm/model. The body detection algorithm/model may function to identify human bodies existing in the time recording data stream and/or delineate the identified bodies from one another and/or other objects within a scene. In a preferred embodiment, to delineate the identified bodies in the time recording data stream from one another, the body detection model may apply a unique (e.g., color-coded) pixel mask to each identified body. Additionally, or alternatively, to delineate the distinct bodies identified in the time recording data stream from one another, the body detection model may individually encapsulate/bound each identified body (e.g., via distinct bounding boxes). It shall be noted that the body detection algorithm/model may also function to similarly identify/detect non-body related objects, which in turn, may eliminate false positive body detections in the time recording stream.

For instance, in a non-limiting example, the time recording data stream may include a plurality of frames (images) of the time recording scene. The body detection algorithm may receive a respective frame (e.g., representation) of the time recording data stream as input and produce a body-segmented image of the respective frame as output. If the time recording scene during the respective frame includes one or more bodies, the segmented image may uniquely mask or uniquely code each of the one or more bodies (e.g., a first body has a first pixel mask, a second body has a second pixel mask, etc.). Similarly, if the time recording scene during the respective frame includes one or more non-body objects (e.g., ceilings, walls, floors, furniture, and/or the like), the segmented image may generally, or uniquely, mask each of the one or more non-body objects as “nonbody” objects. Other frames of the time recording data stream may be processed by the body detection model in a similar manner as described above and throughout the embodiments of the present application.

### Pose Detection

In some embodiments, S220 may function to detect a pose for the one or more bodies identified in the time recording data stream. To detect a pose of a respective body in the time recording data stream, S220 may first function to generate or isolate an image of the respective body by extracting pixels from the time recording data stream corresponding to the respective body (e.g., the pixel mask corresponding to the respective body). Accordingly, the generated image of the respective body may only include a representation of that respective or singular body and may not include representations of other bodies and/or representations of non-body objects that may exist beyond a respective bounding box or respective outline of the target body. It shall be noted that, in cases in which the time recording data stream includes a plurality of bodies, S220 may function to concurrently generate and/or isolate images for the plurality of bodies (as opposed to generated sequentially in which one image of a body may be generated at a time).

Additionally, while or after generating images corresponding to the one or more bodies identified in the time recording data stream, S220 may also function to concurrently instantiate one or more instances of a pose detection model for each of the one or more bodies identified by the body detection model. Creating distinct instances of the pose detection model may allow poses of the one or more bodies in the time recording data stream to be computed in parallel (as opposed to computed sequentially in which poses of the one or more bodies may be determined one at a time). At least one technical benefit of such embodiment may be an accelerated detection and computation of bodies in a predetermined pose indicating a likely intent of a user to perform a time recording action or gesture. Thus, in such embodiments, a technical effect of accelerating a computing and/or detection by a computing system of whether a required pose and/or time recording gesture (as described below) has been achieved by entities in identified in a given scene. Further, in such embodiments, the technical effect of accelerated computing may be achieved based on the automatic instantiation of a plurality of distinct virtual machines or a plurality of distinct computing stages or pipelines that may be capable of ingesting input of data from each detected body in a proper propose and in a parallel manner process predicted pose data, identity-recognition data (e.g., facial recognition data), and/or time-recording gesture or posture data since each virtual machine or the like may be capable of instantiating the plurality of distinct modules used for pose identification, identity-recognition, and/or time-recording recognition.

The instantiated instances of the pose detection model may function to receive a generated image of a respective body as input and, in turn, detect one or more body parts captured in the provided image of the respective body (e.g., head, hands, feet, hips, shoulders, and/or elbows, etc.) and/or determine positions of the one or more body parts detected in the provided image of the respective body (e.g., X, Y, and/or Z coordinates corresponding to each detected body part). In other words, in cases where the time recording data stream includes a plurality of bodies, S220 may function to generate dedicated images corresponding to each of the plurality of bodies identified in the time recording data stream and provide those generated images to distinct instances of a pose detection model. The distinct instances of the pose detection model, in turn, may detect which body parts may be present in the provided image of a subject body and/or determine X (distance), Y (height), and/or Z (depth) coordinates of the body parts detected in the provided image of the subject body.

### Time Recording Pose Criteria

In some embodiments, the computed X, Y, and/or Z coordinates for one or more body parts of a target body may be used, by S220, to assess whether the target body satisfies time recording pose criteria. In a first implementation, S220 may function to determine that the target body satisfies time recording pose criteria if a height (e.g., Y coordinate) of a first body part of the target body (e.g., hand) is above a height (e.g., Y coordinate) of at least a second body part of the target body (e.g., head and/or shoulders). Conversely, S220 may function to determine that the target body does not satisfy the time recording pose criteria if the height of the first body part of the target body is below the height of the second body part of the target body.

Additionally, or alternatively, in a second implementation, S220 may function to determine that the target body satisfies the time recording pose criteria if a distance between a third body part of the target body and a fourth body part of the target body (e.g., distance between an X-coordinate of the third body part and an X-coordinate of the fourth body part) is more than a threshold distance (e.g., 12 inches, 24 inches, 36 inches, etc.). Conversely, S220 may function to determine that the target body does not satisfy the time recording pose criteria if the distance between the third body part of the target body the fourth body part of the target body may not at least the threshold distance apart.

Additionally, or alternatively, in a third implementation, S220 may function to determine that the target body satisfies the time recording pose criteria if a first body part of the target body (e.g., hand) is above (or below) a second body part of the target body (e.g., shoulders) by at least a threshold amount (e.g., 12 inches, 24 inches, 36 inches, etc.). Conversely, S220 may function to determine that the target body does not satisfy the time recording pose criteria if the first body part of the target body (e.g., hand) is not above (or below) the second body part of the target body (e.g., shoulders) by at least the threshold amount (e.g., 12 inches, 24 inches, 36 inches, etc.).

It shall be recognized that the time recording pose criteria may be set in any suitable manner including, but not limited, criteria that set relative positioning requirements between distinct body parts of a target user for satisfying or defining a predetermined time recording pose.

In some embodiments, in cases where the time recording data stream includes a plurality of bodies, S220 may function to concurrently detect a pose for each of the plurality of bodies. Thus, in such embodiments, S220 may function to concurrently detect that a subset of the bodies in the time recording data stream satisfy the time recording pose criteria, that a subset of the bodies in the time recording data stream do satisfy the time recording pose criteria, that none the bodies in the time recording data stream satisfy the time recording pose criteria, and/or that all the bodies in the time recording data stream satisfy the time recording pose criteria.

When a respective body identified in the time recording data stream satisfies the time recording pose criteria, the automated electronic time recording service may recognize that the respective body may be intending to record time to the automated electronic time recording service. Conversely, if a respective body identified in the time recording data stream does not satisfy the time recording pose criteria, the automated electronic time recording service may recognize that the respective body may not be intending to record time to the automated electronic time recording service-thus minimizing the processing of unintended time recording transactions (e.g., minimizing the recording of unintended punch transactions to the automated electronic time recording service).

As will be described in more detail below, in some embodiments, in response to determining that one or more bodies in the time recording data stream satisfy the time recording pose criteria, S220 may function to extract probative portions from the one or more generated images of the one or more bodies (e.g., extract the heads of the one or more bodies, the hands of the one or more bodies, and/or the like) and forward those extracted probative portions to time recording recognition models.

### Body Location Detection

In a variant implementation, the computed X, Y, and/or Z coordinates for one or more body parts of a target body may be used, by S220, to determine a location of the target body within the time recording scene. In such embodiments, S220 may function to compare an X, Y, and/or Z location of a body part (e.g., foot) to known boundary (e.g., perimeter) coordinates of the time recording zones in the time recording scene. If S220 determines that the X, Y, and/or Z location of a body part exists within a respective time recording zone boundary, S220 may function to determine that the target body may be located within that respective time recording zone. For instance, in a nonlimiting example, S220 may function to determine that a target body may be located within a first time recording zone if an X, Y, and/or Z location of a foot of the target body exists within the X, Y, and/or Z boundary of the first time recording zone. Conversely, S220 may function to determine that the target body may be located within a second time recording zone if the X, Y, and/or Z location of the foot of the target body exists within the X, Y, and/or Z boundary of the second time recording zone. In some portions of the disclosure, the determination related to a target body's location within the time recording scene may be referred to as a “location signal.”

### 2.30 User Identity Recognition

S230, which includes detecting an identity of one or more bodies, may function to identify or detect an identity of the one or more bodies captured/detected in the time recording data stream. It shall be noted that if S220 detected that one or more bodies in the time recording data stream did not satisfy the time recording pose criteria, S230 may not function to detect an identity for those one or more bodies. Alternatively, it shall also be noted that if S220 detected that a plurality of bodies in the time recording data stream satisfied the time recording pose criteria, S230 may function to concurrently (or simultaneously) detect an identity for each of those plurality of bodies—as opposed to sequentially detected.

In one or more embodiments, S230 may function to implement a facial recognition model (or user-recognition model) to compute an identity of a target body. In such embodiments, the facial recognition model may function to receive an image of a head of the target body as input and derive an identity of the target body as output, such as a name associated with the target body, an identification number associated with the target body (as described in S210), contact information associated with the target body, and/or the like. The output of the facial recognition model in some portions of the disclosure may be referred to herein as an “identification signal” and/or an identification inference. It shall be noted that in cases where the time recording data stream includes a plurality of bodies that satisfy the time recording pose criteria, S230 may function to instantiate a plurality of instances of the facial recognition model to concurrently compute an identity associated with the plurality of bodies.

The image of the head of the target body that may be provided to the facial recognition model may have been created based on or extracted from the image of the target body generated in S220. That is, in response to determining that the target body satisfied the time recording pose criteria, S230 may function to generate the image of the head of the target body by extracting pixels, from the generated image of the target body in S220, that correspond to the head of the target body.

Additionally, or alternatively, to the embodiment described above, the facial recognition model may function to receive an image of a head of the target body as input and produce a facial feature vector associated with the head of the target body as output. The facial feature vector may include one or more values corresponding to one or more facial features represented in the image of the head of the target body, such a computed value corresponding to the eyes of the target body, a computed value corresponding to the nose of the target body, a computed value corresponding to the ears of the target body, a computed value corresponding to the lips of the target body, a computed value corresponding to the chin of the target body, and/or the like. The facial feature vector computed for the target body may then be compared to a plurality of reference facial feature vectors that are digitally associated with a plurality of potential users of the automated electronic time recording service to determine an identity of the target body.

In some cases, the image of the head of the target body may not be of sufficient image quality or image resolution to allow the facial recognition model to accurately derive an identity of the target body. That is, the image of the head of the target body may have an insufficient number of pixels (e.g., less than a threshold number of pixels) to detect an identity of the target body. As a result, the facial recognition model may return an indication indicating a facial recognition matching failure (e.g., insufficient pixels in image, etc.) or an indication of no facial match based on the image of the head of the target body. When the facial recognition model returns such an indication, S230 may function to forgo executing the remaining steps of method 200 and transmit the time recording data stream identified in S220 (or at least a portion of the time recording data stream) to a predetermined entity to assess the time recording intent of the target body (e.g., administrator, human arbiter, etc.).

Conversely, in some embodiments, the facial recognition model may not be able to identify the target body even if the image of the head of the target body may be of sufficient quality. This may occur because a user associated with the target body has not been previously enrolled to the automatic electronic time recording system (as described in S210). Accordingly, in such cases, S230 may function to initiate a process to automatically enroll or automatically enroll—optionally with no additional user input—the user associated with the target body to the automatic time recording service in similar ways described in S210 based at least on the extracted image of the head of the target body.

It shall be noted that S230 may additionally, or alternatively, function to use other suitable biometric data including, but not limited to, voice biometric data, gait biometric data, and/or the like captured in the time recording data stream to an identify an identity of a target body (e.g., in analogous ways described above).

In a variant implementation, S230 may function to determine an identity of one or more target users within a time recording scene based on identifying and processing a computer-readable or computer-identifiable indicia positioned along a respective body (as extracted by S220). The computer-identifiable indicia may include any suitable indicia including, but not limited to, one or more characters (e.g., alphanumeric characters), an image (e.g., a drawing, cartoon character), readable code (e.g., QR code or the like), and the like. In a similar manner, as described herein, S230 may function to process the computer-identifiable indicia to identify an identity or identity account value of each of the one or more target users within the time recording scene.

### 2.40 Time Recording Gesture Recognition

S240, which includes detecting time recording gestures, may function to detect time recording gestures performed by the one or more bodies identified in the time recording data stream. In one or more embodiments, bodies in the time recording data stream may perform a time recording gesture to record (or indicate) a start of a new time recording activity to the automated electronic time recording service (e.g., started working, started lunch, started a break, and/or the like) and/or to record (or indicate) an end of an activity to the automated electronic time recording service (e.g., stopped working, finished lunch, finished the break, and/or the like). Additionally, or alternatively, bodies in the time recording data stream may perform non-explicit or general time recording gestures. As generally referred to herein, non-explicit or general time recording gestures may not indicate a specific time recording activity to which the time recording gesture corresponds, and thus requires the automated electronic time recording service or a time recording application in operable communication with the automated electronic time recording service (or system) to derive the associated time recording activity based on past time recording actions performed by that respective body.

In some embodiments, if S220 functioned to determine that a plurality of bodies detected in the time recording data stream satisfied the above-described time recording pose criteria, one or more functions of S240 may be performed, concurrently or contemporarily, for those plurality of bodies. Additionally, or alternatively, if S220 functioned to determine that one or more bodies detected in the time recording data stream did not satisfy the above-described time recording pose criteria, one or more functions of S240 may not be performed for those one or more bodies.

In one or more embodiments, S240 may function to implement a time recording gesture recognition algorithm to detect which time recording gesture a target body performed. In such embodiments, the time recording gesture recognition algorithm may function to receive an image of a hand of the target body as input (or an image of another body part) and provide a name of the corresponding performed time recording gesture as output. It shall be noted that the time recording gesture recognition algorithm or model may be able to detect single-part time recording gestures and/or multi-part time recording gestures, as will be described in more detail herein.

Additionally, or alternatively, to the embodiment described above, the time recording gesture recognition algorithm may function to receive an image of the hand of the target body as input and produce a hand pose estimation vector associated with the hand of the target body as output. The hand pose estimation vector may include one or more values that indicate the pose of the hand of the target body. The hand pose estimation vector computed for the target body may then be compared to a plurality of reference hand pose vectors digitally associated with a time recording code/action (e.g., clock-in, clock-out, etc.) to determine the time recording activity performed by the hand of the target body.

In some embodiments, the input provided to the time recording gesture recognition algorithm or model may correspond to the portion of the target body that satisfied the time recording pose criteria. For instance, in a non-limiting example, if the target body satisfied time recording pose criteria because a first (e.g., right) hand of the target body was located above one or more shoulders of the target body, S240 may function to provide an image of the first (e.g., right) hand of the target body to the time recording gesture recognition algorithm. Conversely, in a second non-limiting example, if the target body satisfied the time recording pose criteria because a second (e.g., left) hand of the target body was located above one or more shoulders of the target user, S240 may function to provide an image of the second (e.g., left) hand of the target body to the time recording gesture recognition algorithm.

The image provided to the time recording gesture recognition algorithm may have been extracted (or cropped) from the image generated for the target body in S220. That is, in response to determining that a target body satisfied the time recording pose criteria, S240 may function to generate the image of the hand of the target body by extracting pixels, from the generated image of the target body in S220, that correspond to the hand of the target body that caused the time recording pose criteria to be satisfied.

After providing the image of the hand of the target body as input to the time recording gesture recognition algorithm, the time recording gesture recognition algorithm may compute an identifier or the name of the performed time recording gesture (or a time recording code) as output. For instance, in a non-limiting example, if the image of the hand of the target body indicates a first hand pose (e.g., all the fingers of the hand are curled towards the palm of the hand), the time recording gesture recognition algorithm may compute that the image of the hand of the target body corresponds to a first time recording gesture or activity (e.g., clock-in gesture). Conversely, if the image of the hand of the target body indicates a second hand pose (e.g., all the fingers of the hand are extended away from the palm of the hand), the time recording gesture recognition algorithm may compute that the image of the hand of the target body corresponds to a second time recording gesture or activity (e.g., clock-out gesture). It should be understood that the image of the hand of the target body may correspond to a plurality of possible handshapes, and thus correspond to a plurality of possible distinct time recording gestures. It shall be recognized that the time recording gesture recognition algorithm may function to compute a time recording code, which may be one of a plurality of distinct time recording codes of the time recording system and/or service. In such embodiments, each of the plurality of distinct time recording codes may be mapped to or electronically associated with one distinct electronic time recording action of a plurality of distinct time recording actions (e.g., clock-in, clock-out, transfer, meal break, and/or the like).

Additionally, or alternatively, the time recording recognition algorithm may function to detect multi-part time recognition gestures. Multi-part time recognition gestures may be gestures that contain multiple parts or portions that must be performed in succession of each other within a threshold amount of time (e.g., 5, 10, 15, 20, 25, 30, 60, 90, and/or like seconds). For instance, in a non-limiting example, a first multi-part time recognition gesture may require that two distinct “closed” first hand poses be detected within the threshold amount of time. Similarly, a second multi-part time recognition gesture may require that n-number of distinct hand poses be detected within the threshold amount of time.

Accordingly, in such embodiments, S240 may function to receive, from S220, images of the target body over different frames in the time recording data stream-preferably frames in the time recording data stream where the target user was satisfying the time recording pose criteria. In response to receiving the images of the target body, S240 may function to extract the hand of the target body that satisfied the time recording pose criteria from each of the plurality of images and generate a chronologically ordered “gesture sequence” image that includes the extracted hand from each of the of the plurality of images. This gesture sequence image may then be provided to the time recording gesture recognition algorithm to predict the time recording gesture or action performed by the target body.

In some cases, the image of the hand of the target body may not be of sufficient image quality or image resolution to allow the time recording gesture recognition algorithm to accurately detect which time recording gesture the target body performed. In such embodiments, the time recording gesture recognition algorithm may return an indication indicating a time recording gesture recognition failure (e.g., insufficient pixels in image, etc.). When the time recording gesture recognition algorithm returns such an indication, S240 may function to forgo executing the remaining steps of method 200 and transmit the time recording data stream identified in S220 (or at least a portion of the time recording data stream) to a predetermined entity (e.g., administrator, human arbiter, etc.) to assess the time recording intent of the target body.

Conversely, in some embodiments, the time recording gesture recognition model may not be able to identify the performed time recording gesture even if the image of the gesture-performing body part of the target body may be of sufficient quality or even if a calculated confidence or inference probability satisfies a gesture-recognition threshold (e.g., a minimum confidence or inference probability value). This may occur because the target body performed a non-explicit or general time recording gesture, as described previously. In such embodiments, the time recording gesture recognition algorithm may return an indication that the target body performed an implicit time recording gesture. In a variant implementation, S240 may function to route the image of the gesture-performing body part of the target body to a time recording review queue. In such variant implementation, if an identity of the target body may be known or discoverable, S240 may function to route the gesture-performing body part together with a target body user identifier to a review queue user interface for an enhanced review or assessment and a calculated disposal of the intended time recording action.

It shall be noted that the output of the time recording gesture recognition algorithm in some portions of the disclosure may be referred to herein as a “time recording gesture signal” and/or a “time recording action inference.”

### 2.50 Time Recording

S250, which includes automated electronic time recording, may function to compute an intended time recording action for one or more target bodies. Additionally, or alternatively, S250 may function to transmit confirmation or verification time recording notifications to the users associated with the one or more target bodies. It shall be noted that, in embodiments where S220 detected that a plurality of bodies in the time recording data stream satisfied the time recording pose criteria, S250 may function to compute an intended time recording action for each of the plurality of bodies in parallel (as opposed to sequentially computing the intended time recording action for each of the plurality of bodies).

In some embodiments, S250 may function to determine an intended time recording action for a target body based on a corresponding user identification (e.g., employee identifier) signal computed for the target body, a corresponding time recording gesture signal computed for the target body, and/or a corresponding location signal computed for the target body. That is, for a first target body, S250 may function to compute or derive the intended time recording action corresponding to the first target body based on the identification signal computed for the first target body, a time recording gesture signal computed for the first target body, and/or a location signal computed for the first target body. Conversely, for a second target body, S250 may function to compute the intended time recording action corresponding to the second target body based on an identification signal computed for the second target body, a time recording gesture signal computed for the second target body, and/or a location signal computed for the second target body (e.g., different signals as compared to the signals used to compute the intended time recording action of the first target body).

In one or more embodiments, computing or deriving the time recording action may include receiving a distinct time recording signal in association with a unique user account or user identifier value (signal). In such embodiments, if the time recording signal comprises a time recording code or the like, S250 may function to perform a time recording action lookup or search using the code. In one example, the method 200 may implement and/or access one or more data structures, such as code lookup tables, that S250 may function to access via a lookup or search with a given time recording code to identify an appropriation time recording action or time recording entry.

In some embodiments, the time recording activity performed by the target body may be registered as an entry into a time recording database of the automated electronic time recording service (or registered as an entry into a time recording database communicatively coupled with the automated electronic time recording service). To register the time recording activity performed by the target body as an entry into the time recording database, electronic ledger, or electronic journal, the entry may require one or more of the following to be specified: (1) an ID associated with the target body that performed the time recording activity, (2) the job task associated with the time recording activity, (3) the time recording activity type corresponding to the time recording activity, and/or (4) a time stamp (e.g., a date/time of time recording activity) and in some embodiments, a time stamp location identifier (e.g., timeclock identifier). Additionally, or alternatively, the time recording entry may be posted or recorded to an account associated with a distinct user or employee user. In such embodiments, the account of the user may include one or more electronic media dedicated to the user account for recording time recording activities or entries.

S250 may additionally or alternatively function to store a copy of the image of time recording gesture and/or a copy of the image of the body segment used for identification in association with the time recording entry. In this way, a confirmation or validation (including electronic auditing) may be performed for each time recording entry to ensure a technical accuracy of the gesture recognition model and user identification recognition model.

In a preferred embodiment, the ID associated with the target body that is specified in the above-described entry may correspond to the User ID indicated in the identification signal computed for the target body (as described in S230). This may, if the identification signal computed for the target body indicates a first User ID, the User ID specified in the above-described database entry may be the first User ID. Conversely, if the identification signal computed for the target body indicates a second User ID, the User ID specified in the above-described database entry may be the second User ID.

Additionally, or alternatively, in a preferred embodiment, the job task that is specified in the above-described entry may be based on the location signal computed for the target body. The location signal, as previously described in S220, may indicate the time recording zone in which the target body may be located. Accordingly, if the location signal computed for the target body indicates that the target body is located within a first time recording zone, the job task specified in the above-described database entry may be the job task that corresponds to the first time recording zone (e.g., a first job task). Conversely, if the location signal computed for the target body indicates that the target body is located within a second time recording zone, the job task specified in the above-described database entry may be the job task that corresponds to the second time recording zone (e.g., a second job task). It shall be noted that, in some embodiments, a job task does not need to be provided in order to record a time recording activity to the time recording database.

Additionally, or alternatively, in a preferred embodiment, the time recording activity type that is specified in the above-described entry may be based on the time recording gesture signal computed for the target body. The time recording gesture signal, as previously described in S240, may indicate the time recording gesture performed by the target body. Accordingly, if the time recording gesture signal computed for the target body indicates that the target body performed a first time recording gesture, the time recording activity type specified in the above-described database entry may be the time recording activity type that corresponds to the first time recording gesture (e.g., clock-in if the first time recording gesture corresponds to a clock-in gesture). Conversely, if the time recording gesture signal computed for the target body indicates that the target body performed a second time recording gesture, the time recording activity type specified in the above-described database entry may be the time recording activity type that corresponds to the second time recording gesture (e.g., clock-out if the second time recording gesture corresponds to a clock-out gesture). It shall be noted that S250 may function to (e.g., concurrently) register, to the time recording database, time recording activities of other users in the time recording data stream in similar ways described above.

In some embodiments, a time recording state (e.g., punch state) of the user account associated with the target body may be modified/updated in response to S250 registering a new time recording activity for the target body to time recording database. For instance, before the above-described time recording activity was registered to the time recording database, the user account associated with the target body may have been in a first time recording state (e.g., clocked-in state), and after registering the above-described time recording activity to the time recording database, the time recording state of the user account associated with the target user may have been updated from the first time recording state (e.g., clocked-in state) to a second time recording state (e.g., clocked-out state).

Additionally, in some embodiments, in response to registering a time recording activity performed by a target body to a time recording database, S250 may function to display, via a display generation component of the automated-electronic time recording service, a notification (or indication) that indicates the time recording activity performed by the target body was successfully registered to the time recording database and/or that indicates information relating to the time recording activity. Additionally, or alternatively, in some embodiments, S250 may function to transmit, to an electronic device associated with the user account that corresponds to the target body, a notification (or indication) that indicates the time recording activity performed by the target body was successfully registered to the time recording database and/or that indicates information relating to the time recording activity.

In some embodiments, if an incorrect time recording activity was registered to the time recording database (e.g., the time recording activity computed by S250 differed from the intended time recording activity of the target body), an administrator (or another entity) of the automated electronic time recording service may update the entry in the time recording database corresponding to the time recording activity to reflect the time recording activity intended by the target body and/or trigger model retraining to minimize the automated electronic time recording service from repeating the same computation error in the future (e.g., trigger retraining of the one or more models/algorithms described above).

### 3. Computer-Implemented Method and Computer Program Product

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer readable media such as RAMs, ROMs, flash memory, EEPROMs, optical devices (CD or DVD), hard drives, floppy drives, or any suitable device. The computer-executable component may preferably a general or application specific processor, but any suitable dedicated hardware or hardware/firmware combination device can alternatively or additionally execute the instructions.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

We claim:

1. A method for organizing and presenting time recording information on one or more electronic visual displays, the method comprising:
(1) enrolling a plurality of users into a system by collecting and storing identification data associated with each user;
(2) assigning notification data for each user to one or more electronic visual displays, wherein the notification data includes information related to the user's time recording activities, and the placement of each user's notification data is assigned to a specific area on the electronic visual display;
(3) recognizing, via one or more scene capturing devices, an action performed by one or more users in a time recording space, wherein the action corresponds to a time recording activity;
(4) identifying, via one or more computers, the users performing the time recording action based on the collected identification data;
(5) displaying, on the electronic visual display, notification data for any user recognized as having performed the time recording action, wherein the placement and appearance of the notification data is determined by one or more algorithms;
(6) updating the electronic visual display as new time recording actions are recognized, such that the notification data for the most recent action is displayed in a visually distinct manner.

2. A method for organizing and displaying time recording information on one or more electronic visual displays, the method comprising:
(1) performing an enrollment process that includes assigning a unique identifier to each user and collecting and storing biometric data associated with each unique user to create a biometric reference dataset, wherein the biometric data is associated with each user by the unique identifier, and wherein the biometric reference dataset is utilized by one or more computers to facilitate subsequent identification of users;
(2) Assigning the placement of notification data for multiple users to one or more electronic visual displays, wherein each unique user's notification data is assigned to only one specific display, and to one specific column or one specific row on that display, and, optionally, one or more appearance attributes, where the appearance of the notification data is assigned specific attributes selected from a group consisting of a color selected from a plurality of colors, a font selected from a plurality of fonts, a font style selected from a plurality of font styles, and/or a font size selected from a plurality of font sizes, while allowing multiple users' notification data to share the same display, column or row, and appearance attributes, and wherein the placement and appearance attributes of each user's notification data, including the assigned display, column or row, and, optionally, any appearance attributes, are automatically determined by one or more algorithms running on one or more computers;
(3) recognizing, by one or more computers, a time recording action performed by any of the plurality of users where the action corresponds to a time recording activity, and where the recognition of the performed action is generated by one or more action recognition machine learning models, running on the one or more computers, and where the time recording activity is either classified or unclassified;
(4) identifying, by one or more computers, any of the plurality of users performing the time recording action, where the identification of each unique user is generated by one or more user-identification machine learning models, running on the one or more computers, trained to recognize unique biometric data associated with each unique user;
(5) Displaying, on the electronic visual display, notification data for any user recognized as having performed the time recording action that corresponds to the time recording activity, only if a match is found between the biometric data obtained from the user who performed the action and the biometric data stored from the enrollment process, wherein the placement and appearance of the notification data, including any assigned appearance attributes, are determined by the prior enrollment process, and the notification data includes at least one of the following: the user's name or unique identifier;
(6) Updating the display such that the most recent notification data for each user is shown at the top of the assigned column, with previous notification data moving downward in a vertically oriented column, or, alternatively, beginning at the start of the assigned row and updating horizontally across rows, wherein, if any appearance attributes are assigned, the notification data retains the originally assigned appearance attributes throughout the movement, whether vertically or horizontally, on the display.

3. A method for organizing and displaying time recording information on one or more electronic visual displays, the method comprising: (1) performing an enrollment process that includes assigning a unique identifier to each user and collecting and storing biometric data associated with each unique user to create a biometric reference dataset, wherein the biometric data is associated with each user by the unique identifier, and wherein the biometric reference dataset is utilized by one or more computers to facilitate subsequent identification of users; (2) assigning the placement of notification data for multiple users to one or more electronic visual displays, wherein each unique user's notification data is assigned to only one specific display and to one specific column or one specific row on that display, while allowing multiple users' notification data to share the same display, column or row, and wherein the placement of each user's notification data, including the assigned display, column or row, is automatically determined by one or more algorithms running on one or more computers; (3) informing, via electronic means, each user of their assigned notification data placement on the electronic visual display; (4) identifying, via one or more scene capturing devices, a representation of a time recording space; (5) obtaining, by one or more scene capturing devices, a data stream from the time recording space where the time recording space contains a plurality of users of the system; (6) recognizing, by one or more computers, a time recording action performed by any of the plurality of users where the action corresponds to a time recording activity, and where the recognition of the performed action is generated by one or more action recognition machine learning models running on the one or more computers, and where the time recording activity is either classified or unclassified; (7) identifying, by one or more computers, any of the plurality of users performing the time recording action, where the identification of each unique user is generated by one or more user-identification machine learning models running on the one or more computers, trained to recognize unique biometric data associated with each unique user; (8) displaying, on the electronic visual display, notification data for any user recognized as having performed the time recording action that corresponds to the time recording activity, only if a match is found between the biometric data obtained from the user who performed the action and the biometric data stored from the enrollment process, wherein the placement of the notification data is determined by the prior enrollment process, and the notification data includes at least one of the following: the user's name or unique identifier; (9) updating the display such that the most recent notification data for each user is shown at the top of the assigned column, with previous notification data moving downward in a vertically oriented column, or, alternatively, beginning at the start of the assigned row and updating horizontally across rows.

4. The method of claim 3, further comprising: Assigning one or more appearance attributes to each user's notification data, where the appearance attributes are assigned specific values selected from a group consisting of a color selected from a plurality of colors, a font selected from a plurality of fonts, a font style selected from a plurality of font styles, and/or a font size selected from a plurality of font sizes, wherein multiple users' notification data are allowed to share the same appearance attributes, and wherein the appearance attributes of each user's notification data are automatically determined by the one or more algorithms running on the one or more computers.

5. The method of claim 4, wherein the appearance of the notification data is defined by a color scheme such that: —The text of the notification data appears in the assigned color; or —The text of the notification data is displayed within a shape with a specific solid background fill color being the assigned color, wherein the text color contrasts with the assigned background fill color to ensure legibility.

6. The method of claim 3, wherein each of the one or more electronic visual displays has notification data that is organized into at least two columns or at least two rows.

7. The method of claim 4, wherein the placement and appearance attributes of each user's notification data, including the assigned display, column or row, and appearance attributes, are assigned randomly by the one or more algorithms running on the one or more computers, allowing for a randomized distribution across the available displays, columns or rows, and appearance attributes.

8. The method of claim 3, wherein the placement of each user's notification data, including the assigned display, column or row, is assigned randomly by the one or more algorithms running on the one or more computers, allowing for a randomized distribution across the available displays, columns or rows.

9. The method of claim 4, wherein the placement and appearance attributes of each user's notification data, including the assigned display, column or row, and appearance attributes, are assigned by the one or more algorithms running on the one or more computers to achieve a balanced distribution, wherein the balanced distribution is defined as the system attempting to assign an equal number of users' notification data to each display, an equal number to each column or each row, and an equal number to each appearance attribute within each column or row on the available displays.

10. The method of claim 3, wherein the placement of each user's notification data, including the assigned display, column or row, is assigned by the one or more algorithms running on the one or more computers to achieve a balanced distribution, wherein the balanced distribution is defined as the system attempting to assign an equal number of users' notification data to each display and an equal number to each column or each row on the available displays.

11. The method of claim 3, wherein the system ensures that no two users with the same name have their notification data assigned to the same column or the same row on the electronic visual display by automatically checking user names during the enrollment process and assigning the notification data of users with identical names to different columns, rows, or visual displays.

12. The method of claim 3, wherein the system informs each of the plurality of users of the placement of their notification data, where the electronic means is at least one of the following: email, text message, mobile application, native application, or web application.

13. The method of claim 4, wherein the system informs each of the plurality of users of the placement and appearance attributes of their notification data, where the electronic means is at least one of the following: email, text message, mobile application, native application, or web application.

14. The method of claim 3, wherein, upon the removal of a user from the system, the system automatically identifies the vacated position on the electronic visual display where the removed user's notification data was previously displayed and assigns the notification data for a new user to the same display and the same column or row, in order to maintain a balanced distribution of users' notification data across the available displays, columns or rows, wherein a balanced distribution is defined as the system attempting to assign an equal number of users' notification data to each display and an equal number to each column or each row on the available displays.

15. The method of claim 4, wherein, upon the removal of a user from the system, the system automatically identifies the vacated position on the electronic visual display where the removed user's notification data was previously displayed and assigns the notification data for a new user to the same display, the same column or row, and the same appearance attributes as the removed user, in order to maintain a balanced distribution of users' notification data across the available displays, columns or rows, and appearance attributes, wherein a balanced distribution is defined as the system attempting to assign an equal number of users' notification data to each display, an equal number to each column or each row, and an equal number to each appearance attribute within each column or row on the available displays.

16. The method of claim 3, wherein the biometric data used to identify the plurality of users includes at least one of the following: facial recognition data, fingerprint data, voice recognition data, or gait analysis data.

17. The method of claim 3, wherein the action performed by any of the plurality of users includes at least one of the following: raising a hand above the head, raising a hand above the shoulder line, raising an elbow above the shoulder, waving a hand, stepping into a designated area, walking through a designated area, or performing a verbal command, and wherein the action corresponds to a time recording activity.

18. The method of claim 3, wherein a first user is performing a time recording action and a second user is concurrently performing a time recording action.

19. The method of claim 3, wherein the time recording activity includes at least one of the following: clocking in, clocking out, starting a break, ending a break, starting lunch, or ending lunch.

20. The method of claim 3, wherein the action performed by the users corresponds to an unclassified time recording activity that is subsequently classified based on the timestamp of the activity, contextual analysis, or other data processing rules.

21. The method of claim 3, wherein the assignment of notification data to the electronic visual display, column or row, takes into account the work schedules of users, attempting to achieve a balanced distribution of notification data during times where multiple users are expected to use the system concurrently, wherein a balanced distribution is defined as the system attempting to assign an equal number of users' notification data to each display and an equal number to each column or each row on the available displays.

22. The method of claim 4, wherein the assignment of notification data to the electronic visual display, column or row, and appearance attributes takes into account the work schedules of users, attempting to achieve a balanced distribution of notification data during times where multiple users are expected to use the system concurrently, wherein a balanced distribution is defined as the system attempting to assign an equal number of users' notification data to each display, an equal number to each column or each row, and an equal number to each appearance attribute within each column or row on the available displays.

23. The method of claim 3, wherein the scene capturing devices comprise at least one of a video camera, a thermal imaging camera, a motion sensor, a depth sensor, a lidar sensor, a microphone, or any combination thereof, and are configured to monitor the time recording space and provide data streams to the system for recognizing at least one action performed by the users.

24. The method of claim 3, wherein all of the notification data displayed on the one or more electronic visual displays is programmed to be removed after a predetermined amount of time elapses without a time recording action being recognized by the system, the predetermined amount of time being either hard-coded or defined by an administrator, and wherein, alternatively, the notification data is removed on a rolling basis, such that each unique user's notification data is removed after a predetermined amount of time elapses from the time the unique user's notification data first appeared, the amount of time being either hard-coded or defined by an administrator.

25. The method of claim 3, wherein, in the event that a display in a multi-display configuration malfunctions or becomes unavailable, the system automatically reassigns the notification data of users previously assigned to the malfunctioning display to one or more of the remaining functional displays using the algorithmic process described herein, and wherein the affected users are notified of their new display placement through electronic means, including but not limited to email, text message, mobile applications, native applications, or web applications, with the notification detailing the updated placement, including the specific display, column or row.

26. The method of claim 4, wherein, in the event that a display in a multi-display configuration malfunctions or becomes unavailable, the system automatically reassigns the notification data of users previously assigned to the malfunctioning display to one or more of the remaining functional displays using the algorithmic process described herein, and wherein the affected users are notified of their new display placement and appearance attributes through electronic means, including but not limited to email, text message, mobile applications, native applications, or web applications, with the notification detailing the updated placement, including the specific display, column or row, and any assigned appearance attributes.
